(19) United States
(12) Patent Application Publication
(10) Pub. No.: US 2005/0162339 A1
(43) Pub. Date: Jul. 28, 2005

(54) Remote monitoring apparatus

(75) Inventor: Werner Schneider, Wanganui (NZ)

Correspondence Address: WITHROW & TERRANOVA, P.L.L.C., P.O. BOX 1287, CARY, NC, 27512, US

(73) Assignee: SCHEM N. Z. LIMITED, Wanganui (NZ)

(21) Appl. No.: 10/509,922

(22) PCT Filed: Apr. 3, 2003
(86) PCT No.: PCT/NZ03/00056

(30) Foreign Application Priority Data
Apr. 3, 2002 (NZ) 518124

(51) Int. Cl. G09G 5/00

(52) U.S. Cl. 345/7

(57) ABSTRACT

The general field of this invention is apparatus for use in remote monitoring systems. In its broadest aspect this invention provides apparatus for use in remote monitoring, the apparatus (1) including a video capture means (2), an audio pick up means (3), a transmitter means to transmit the captured video and audio signals and transmit them to a remote location, the apparatus (1) being characterized in that it further includes a mounting means (5) on which the video capture means (2), the audio pick up means (3), and the transmitter means (4), are mounted, with the mounting means (5) being configured and arranged to, in use, be wearable on the head of an operator, the apparatus (1) also further including an electromagnetic radiation shield (6) mounted in the mounting means (4) adjacent the head of the wearer to protect them from electromagnetic radiation.

### TECHNICAL FIELD

The general field of this invention is in apparatus for use in relation to a remote monitoring system. More specifically, the invention relates to remote sensing and monitoring equipment wherein the front-end equipment is substantially carried by a front line human operative.

### BACKGROUND ART

There is a clear need for equipment for the purposes of recording the sights, sounds and other interactions experienced by personnel such as police officers, ambulance officers and the like. Similar equipment is useful in situations like the external inspection of large buildings, and the internal inspection of large storage tanks and pipelines. Existing equipment designed and used for inspection activities is generally impractical for use by police officers and the like in everyday use.

The ability to interact in real time with the front line operator in circumstances such as ambulance and police officers find themselves in every day would be a significant advantage. The ability to supplement the on the ground abilities of an officer with real time access to specialist advice would greatly enhance the operational capabilities of such personnel. Similarly, in the industrial environment having the ability for a front line operator, such as a maintenance person, or lower skilled process work, to take instructions in real time from a specialist adviser able to interact remotely but directly with them would greatly improve operational efficiencies.

Prior art apparatus has various deficiencies which prevents its use in the environments contemplated by the present invention. Most notably the difficulty is with regard to the ability to utilise the invention with soft shell headgear. U.S. Pat. No. 5,742,335, U.S. Pat. No. 6,101,916 and European Patent Specification 861607 are examples of helmet based systems incorporating visual or video image capture, and audio transmission. However, none of the prior art systems have the potential for use in soft shell or semi-soft shell headgear, such as is used by, for example, the police force etc. The helmets are also invariably heavy and bulky, and have multiple external wires and leads, and the power source and audio/video feed transmitters are not incorporated into the helmet itself. These attributes of prior art systems interfere with the ability of the wearer to get on with their normal operative functions—and in the case of, for example, police officers, could lead to concern from members of the public because of the abnormal appearance created.

It is an object of the present invention to provide a system and equipment to at least go some way towards providing these abilities, or which at least provides the public with a useful choice.

### SUMMARY OF THE INVENTION

In its broadest embodiment the present invention provides apparatus for use in remote monitoring, the apparatus including a video capture means, a audio pick up means, a transmitter means to transmit the captured video and audio signals and transmit them to a remote location, the apparatus being characterised in that it further includes a mounting means on which the video capture means, the audio pick up means, and the transmitter are mounted, with the mounting means being configured and arranged to be wearable on the head of an operator, the apparatus also further including an electromagnetic radiation shield mounted in the mounting means adjacent the head of the wearer to protect them from electromagnetic radiation.

Preferably the electromagnetic radiation shield comprises a metal mesh screen shaped to conform to a wearer's head shape.

Conveniently the mesh screen can form the mounting means.

Optimally the apparatus is built into a hat, cap, or brim-ring to facilitate wearability. The hat or cap may be of rigid, semi-rigid, or soft construction.

Preferably the audio pick up comprises a microphone. The microphone can be configured and oriented to predominantly pick up audio from the wearer, in which case a further microphone can be included to pick up background or surroundings audio signals.

Optionally the apparatus can further include an audio receiver to enable a wearer to receive audio based instructions or advice from a remote assistant or adviser.

The apparatus can optionally also further include a video receiver and screen. Preferably in such a case the video screen would be mounted on an adjustable boom which can position the screen in front of the wearer's eye.

It will be appreciated that a significant advantage of the present invention as outlined above is that it provides a front line operator with a head-carried apparatus establishing a telepresence for an observer remote from the front-end site.

Optionally the apparatus can include a light means to facilitate recordal of video in low light conditions.

Preferably the apparatus also includes a power supply mounted adjacent the mounting means, although equally the power supply can be mounted, for example, on a belt loop or the like and connected via cable to power the apparatus components.

Desirably the apparatus further includes a power supply switch to enable the supply of electrical power to the apparatus to be switched on or off.

### BRIEF DESCRIPTION OF THE DRAWINGS

Preferred embodiments of the invention will now be described, by way of example only, with reference to the accompanying drawings in which:

FIG. 1: Shows a cut away side elevation of an apparatus according to the present invention;

FIG. 2: Shows in side elevation the apparatus of FIG. 1 on a wearer;

FIG. 3: Shows a cut away side elevation of an alternative embodiment of the present invention on a wearer; and

FIG. 4: Shows a rear elevation of the apparatus of FIG. 3.

### DETAILED DESCRIPTION OF THE DRAWINGS

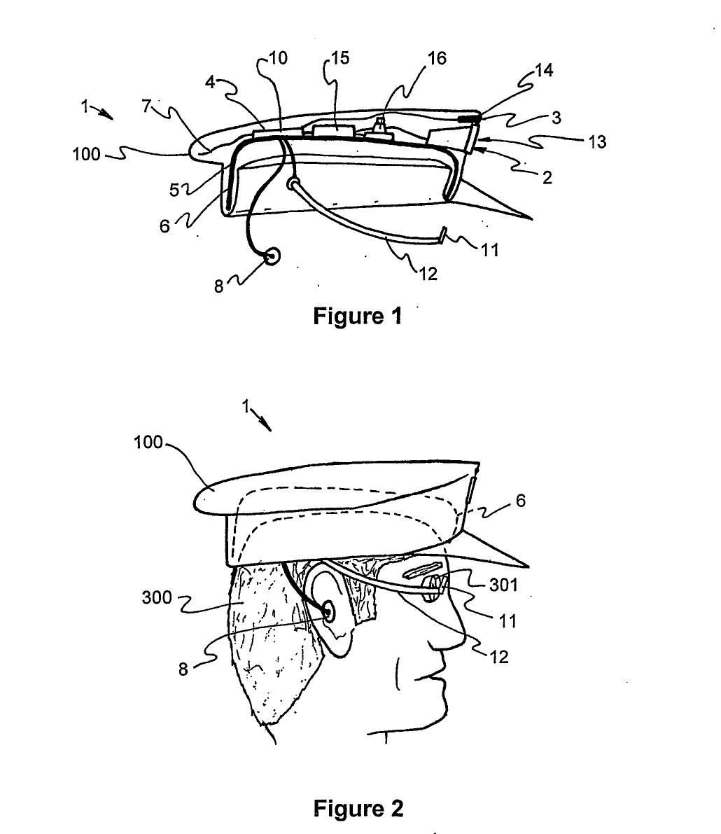

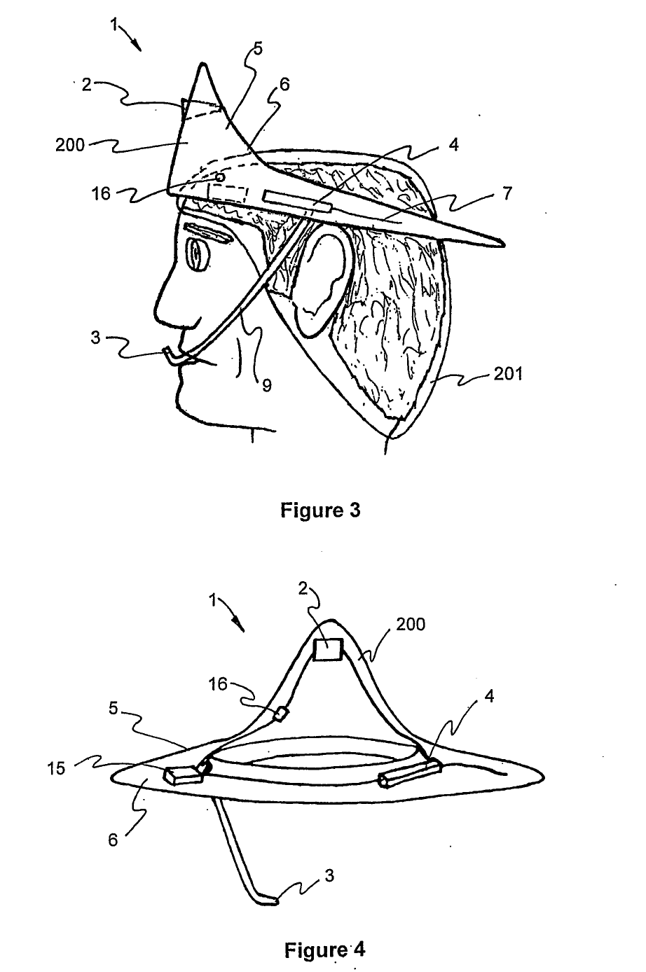

As show in the drawings, the present invention provides a head mounted apparatus 1 for use in remote monitoring. The apparatus 1 is built into a cap 100, as shown in FIGS. 1 and 2, or a brim cap arrangement 200 as shown in FIGS. 3 and 4.

The apparatus 1 includes a video capture means 2 in the form of an analogue or digital video camera, an audio pick up means 3 in the form of an analogue or digital microphone, and at least one transmitter means 4 to transmit the captured video and audio signals and transmit them to a remote location.

In some cases it may be desirable to have two transmitters, one each for the video and audio signals.

The apparatus 1 further includes a mounting arrangement 5 on which the video camera 2, the microphone 3, and transmitter(s) 4 are mounted. The apparatus 1 also further includes electromagnetic radiation shielding 6 to protect the wearer from electromagnetic radiation generated by the transmitter(s) 4. In its preferred form the electromagnetic shielding 6 forms the mounting arrangement 5 for the various other components.

Referring to FIGS. 1 and 2, in the embodiment shown the electromagnetic radiation shield 6 comprises a metal mesh screen shaped to conform to a wearer's head shape. The mesh screen 6 is built into the hat 100 to facilitate wearability. While the hat or cap 100 can be of rigid, semi-rigid, or soft construction, the embodiment illustrated is of a police or ambulance officers the cap 100, which has both rigid and flexible aspects. The mesh 6 assists in providing shape and form to the cap 100.

In its simplest incarnation, the apparatus 1 incorporates a video camera/transmitter 2/4 set that sends a one-way video signal that may be viewed live or recorded. The video signal may incorporate an audio signal fed from the microphone 3. Again referring to use by a police officer for the purposes of example, the captured video and/or audio feed can be transmitted to a digital or analogue recording device located in their police vehicle. Alternatively, it can be transmitted to the police control room. Alternatively still, the audio feed can be transmitted to the control room and the video feed transmitted to the police vehicle. This latter set up providing a useful compromise between real time support for the officer on the beat, and visual record keeping for later verification purposes.

Alternatively the apparatus 1 can include a separate microphone/audio transmitter 3/4 and/or an audio receiver/earpiece 7/8. This will provide no-audio, one-way audio or two-way audio options. If a separate microphone 3 is included it may be placed directly on the apparatus 1 or mounted on an adjustable boom 9 (refer FIGS. 3 & 4).

The apparatus 1 can also include a video receiver/video screen 10/11. The video screen 11 can be mounted on an adjustable boom 12 so as to position the video screen 11 directly in front of the eye 301 of the wearer 300. In low light conditions it can be helpful to include a light source 13 to facilitate recordal of video, although the video camera 2 itself should optimally be operable in low light conditions without such assistance.

The microphone 3 can be configured and oriented to predominantly pick up audio from the wearer 300, in which case a further microphone 14 can be included to pick up background or surroundings audio signals.

The apparatus also requires a power supply 15. For maximum convenience this should be mounted in the cap 100 or brim-ring 200, although equally the power supply 15 can be mounted, for example, on a belt loop or the like (not shown) and connected via cable to power the apparatus components. In the embodiment of FIG. 1 the power supply 15 comprises a small battery pack mounted in the cap 100. It can be accessed via a concealed flap (not shown) in the top of the cap 100. An electrical power supply switch 16 to enable the supply of electrical power to the apparatus 1 to be switched on or off is also optimal. This should be located for convenient activation. In the embodiment of FIG. 1 the switch can be activated by pressing down on the fabric top of the cap 100.

The embodiment of the invention shown in FIGS. 3 and 4 incorporates substantially the same features as the embodiment of FIGS. 1 and 2. However, whereas the cap 100 of FIGS. 1 and 2 is intended primarily for use by the likes of police and ambulance officers, the embodiment of FIGS. 3 and 4 has particular application in the food or dairy industries, where hygiene is a significant issue.

The brim-ring 200 design allows the apparatus 1 to be worn over the top of an elasticised disposable hygiene cap 201 of a type commonly used in the food industry. The components of the apparatus 1 are themselves hygienically sealed within a washable housing.

Advantages of the invention are numerous. In the industrial environment these include the ability to provide support for someone installing, commissioning, maintaining or repairing equipment at a remote (even international) site immediately without time loss by travel. The support is typically in the form of an expert who can provide direct supervision and instructions to a lower skilled operator at the remote site. This arrangement can also provide high level technical coverage of all electrical, electronic and mechanic faults without requiring site dedicated personnel, and allows timely innovative solutions to real problems to be found, and thus avoiding solving problems simply by replacing parts which may in fact not be defective. It is this approach to problem solving which ultimately saves considerable machinery down time and lost production cost, as well as machinery component cost saving.

The present invention is ideally suited to integration with a number of other sub-systems. These can include:
Remote communications systems to carry the video and sound to the off site expert and back to the operator
A sensor network to measure equipment variables and relay them to the offsite expert's location.
Software to predict when failures are expected by using this information on the equipment.
Simulation software to provide auditing tools for designs before they are implemented on a site.
A Logbook of previous events that have occurred in the life of the equipment acted on.
Manuals documenting the as built status, as well of procedures for installing, commissioning, maintaining and repairing/replacing equipment.
A remotely located human expert to upgrade the local skills, being familiar with the type of equipment in question, usually as a result of supplying and supporting the equipment in a number of different places.

Accordingly it will be appreciated that changes may be made to the above described embodiments of the invention without departing from the principles taught herein. For example, where in the foregoing description reference has been made to integers or components having known equivalents then such equivalents are herein incorporated as if individually set forth.

Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the appended claims.

1-15. (canceled)

16. An apparatus for use in remote monitoring configured and arranged to be wearable on the head of an operator, comprising:
a video capture means;
an audio pick up means;
a transmitter means to transmit the captured video and audio signals to a remote location; and
an electromagnetic radiation shield in the form of a metal mesh screen shaped to conform to a wearer's head shape and to substantially protect the wearer's head from electromagnetic radiation emitted from said transmitter means, said metal mesh screen being further adapted to mount and locate said transmitter means thereon.

17. The apparatus of claim 16 wherein said metal mesh screen is further adapted to mount the video capture means and the audio pick up means.

18. The apparatus of claim 16 wherein the apparatus is built into a hat, cap, or brim-ring to facilitate wearability.

19. The apparatus of claim 17 wherein the apparatus is built into a hat, cap, or brim-ring to facilitate wearability.

20. The apparatus of claim 18 wherein the hat or cap is of rigid, semi-rigid, or soft construction.

21. The apparatus of claim 16 wherein the audio pick up comprises a microphone.

22. The apparatus of claim 17 wherein the audio pick up comprises a microphone.

23. The apparatus of claim 21 wherein the microphone is configured and oriented to predominantly pick up audio from the wearer, and the apparatus includes a second microphone to pick up background or surroundings audio signals.

24. The apparatus of claim 16 further comprising an audio receiver to enable a wearer to receive audio based instructions or advice from a remote assistant or adviser.

25. The apparatus of claim 17 further comprising an audio receiver to enable a wearer to receive audio based instructions or advice from a remote assistant or adviser.

26. The apparatus of claim 16 wherein the apparatus further includes a video receiver and screen.

27. The apparatus of claim 26 wherein the video screen is mounted on an adjustable boom which, in use, can position the screen in front of the wearer's eye.

28. The apparatus of claim 16 wherein the apparatus further includes a light means to facilitate recordal of video in low light conditions.

29. The apparatus of claim 17 wherein the apparatus further includes a light means to facilitate recordal of video in low light conditions.

30. The apparatus of claim 16 wherein the apparatus further includes a power supply mounted adjacent the mounting means.

31. The apparatus of claim 17 wherein the apparatus further includes a power supply mounted adjacent the mounting means.

32. The apparatus of claim 16 wherein the apparatus further includes a power supply adapted to, in use, be mounted on a belt loop or the like and connected via cable to power the apparatus components.

33. The apparatus of claim 17 wherein the apparatus further includes a power supply adapted to, in use, be mounted on a belt loop or the like and connected via cable to power the apparatus components.

34. The apparatus of claim 30 wherein the apparatus further includes a power supply switch to enable the supply of electrical power to the apparatus to be switched on or off.

35. The apparatus of claim 32 wherein the apparatus further includes a power supply switch to enable the supply of electrical power to the apparatus to be switched on or off.
